(19) United States
(12) Patent Application Publication
(10) Pub. No.: US 2015/0069718 A1
(43) Pub. Date: Mar. 12, 2015

(54) METAL GASKET ASSEMBLY

(71) Applicant: Federal-Mogul Corporation, Southfield, MI (US)

(72) Inventors: Tyler Haberer, Southfield, MI (US); Michael J. Davidson, Royal Oak, MI (US)

(73) Assignee: Federal-Mogul Corporation, Southfield, MI (US)

(21) Appl. No.: 14/025,191

(22) Filed: Sep. 12, 2013

(51) Int. Cl. F02F 11/00

(52) U.S. Cl. CPC F02F 11/002
USPC 277/593; 277/594

(57) ABSTRACT

A metal gasket for establishing a seal between a first member and a second member is provided. The metal gasket includes at least one functional layer with an inner periphery which surrounds an opening. The functional layer also has a generally flat portion and an embossment bead with the embossment bead being spaced from the inner periphery and surrounding the opening. The embossment bead extends in a first direction away from the generally flat portion, has an indentation which extends in a second direction opposite of the first direction and has a bead height of greater than 0.15 mm and no greater than 0.30 mm.

### BACKGROUND OF THE INVENTION

1. Field of the Invention

The present invention relates generally to gaskets and more particularly to metal gaskets having a functional layer and an embossment bead.

2. Related Art

In establishing a gas tight seal between two members to be clamped together, such as a cylinder head and an engine block, it is common to use a cylinder head gasket having one or more layers. Generally, at least one of the layers is a functional layer which has an embossment bead that deforms elastically when the metal gasket is sandwiched between the cylinder head and the engine block, thereby establishing a gas-tight seal. It is important that this gas-tight seal is maintained even during relative movement of the members being sealed, e.g. lifting of the cylinder head away from the engine block during operation of the engine to keep combustion gasses from escaping the combustion chambers. One approach that some gasket manufacturers have taken to ensure that the gas-tight seal is maintained during operation of the engine is to increase the thickness of the gasket in certain locations, thereby increasing the biasing force by the combustion bead against the engine block or the cylinder head. Another approach that some gasket manufacturers have taken is to include one or more compression limiters adjacent the embossment beads of their gaskets to restrict full flattening of the embossment bead between the cylinder head and the engine block.

Yet another alternate approach is to form the embossment bead with an indentation formed at its apex so that the embossment bead is M or W shaped when viewed in cross-section. At least one known gasket has such an M or W shaped embossment bead that has a height of between 0.04 to 0.15 mm when in an uncompressed state. The indentation in the embossment bead of this type of gasket functions as a compression limiter to restrict full flattening of the embossment bead, i.e. the stopper feature is built into the embossment bead.

### SUMMARY OF THE INVENTION

One aspect of the present invention includes a metal gasket for establishing a seal between a first member, such as a cylinder head, and a second member, such as an engine block. The metal gasket includes at least one functional layer with an inner periphery that surrounds an opening and has a generally flat portion. The functional layer additionally has an embossment bead which is spaced from the inner periphery and surrounds the opening and extends in a first direction away from the generally flat portion. The embossment bead on the functional layer includes an indentation which extends in a second direction opposite of the first direction for providing the embossment bead with three points of contact as viewed in cross-section when compressed between the first and second members. The embossment bead also has a bead height that is greater than 0.15 mm and is no greater than 0.30 mm when in an uncompressed state. This particular range in the bead height is advantageous because it provides optimum sealing performance with reduced forming stresses and increased fatigue resistance as compared to shorter embossment beads with similar shapes.

Another aspect of the present invention provides for a metal gasket for establishing a seal between a first member, such as a cylinder head, and a second member, such as an engine block. The metal gasket includes at least one functional layer which has an inner periphery that surrounds an opening. The functional layer also has a generally flat portion and an embossment bead which is spaced from the inner periphery, surrounds the opening and extends in a first direction away from the generally flat portion. The embossment bead on the functional layer further includes an indentation which extends in a second direction that is opposite of the first direction for providing the embossment bead with three points of contact as viewed in cross-section when compressed between the first and second members. The metal gasket further includes a stopper feature which is separate from and adjacent to the embossment bead for restricting full flattening of the embossment bead between the first and second members. As such, the embossment bead with the indentation may be configured for optimizing the seal between the first and second member while the stopper feature restricts the full flattening of the embossment beads, i.e. the sealing performance of the metal gasket is higher than gaskets with U-shaped embossment beads or gaskets with embossment beads that have a built in stopper feature.

Yet another aspect of the present invention is a multi-layer gasket assembly for establishing a seal between a first member (such as a cylinder head) and a second member (such as an engine block). The multi-layer gasket assembly includes at least one functional layer having an inner periphery which surrounds an opening and has a generally flat portion. An embossment bead which is spaced from the inner periphery surrounds the opening and extends in a first direction away from the generally flat section. The embossment bead on the functional layer includes an indentation which extends in a second direction that is opposite of the first direction. The multi-layer gasket assembly further includes a distance layer which overlies the functional layer and a stopper which is sandwiched between the distance layer and the functional layer and extends radially across the embossment bead.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a partially exploded view of an internal combustion engine with a first exemplary metal gasket positioned between a cylinder head and an engine block;

FIG. 2 is a cross-sectional and fragmentary view show of the first exemplary embodiment of the metal gasket in an uncompressed condition;

FIG. 3 is a cross-sectional and fragmentary view of the first exemplary embodiment of the metal gasket in a compressed condition between the cylinder head and the engine block;

FIG. 4 is a top view of the first exemplary embodiment of the metal gasket;

FIG. 5 is a cross-sectional and fragmentary view of a second exemplary embodiment of the metal gasket in an uncompressed condition between the cylinder head and the engine block; and

FIG. 6 is a cross-sectional and fragmentary view of an exemplary multi-layer gasket assembly.

### DESCRIPTION OF THE ENABLING EMBODIMENT

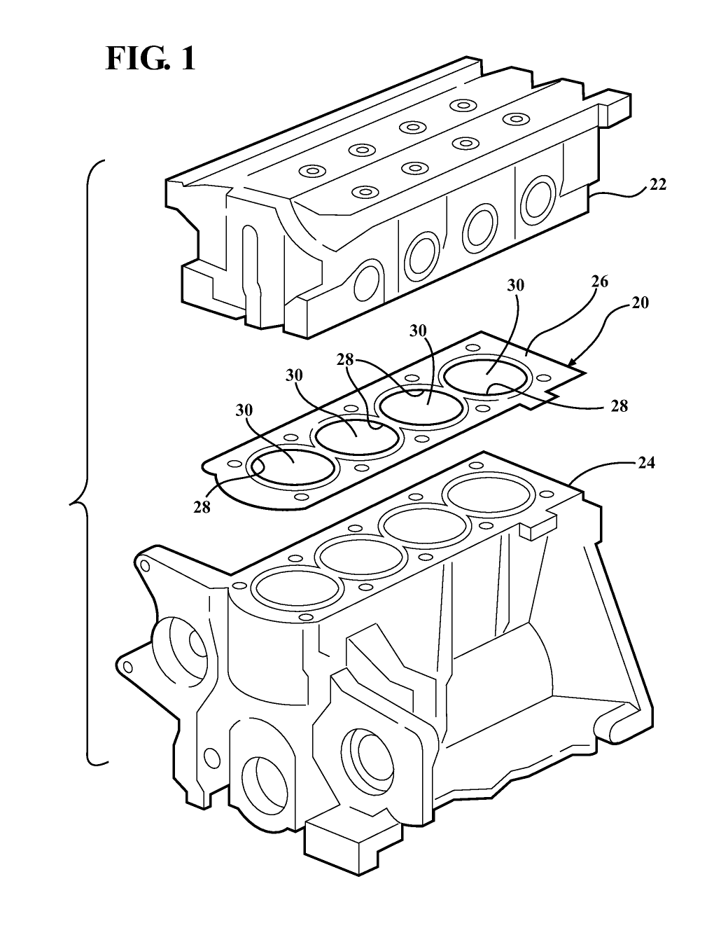

Referring to the Figures, wherein like numerals indicate corresponding parts throughout the several views, a first exemplary embodiment of a metal gasket 20 for establishing a seal between a first member 22 and a second member 24 is generally shown in FIG. 1. In the exemplary embodiment, the metal gasket 20 is a cylinder head gasket configured to establish a gas and fluid tight seal between a cylinder head 22 and an engine block 24 of an internal combustion engine, thereby sealing combustion gasses within a plurality of combustion chambers during operation of the engine. This gas-tight seal is maintained during operation of the engine when the cylinder head 22 may lift off of the engine block 24 in response to a fuel and air combustion within one or more of the combustion chambers. However, it should be appreciated that the metal gasket 20 could find uses in a range of other vehicular or non-vehicular applications, i.e. the metal gasket 20 could be employed to seal any desirable types of first and second members. For example, the metal gasket 20 could be configured to seal an exhaust manifold (not shown) to the engine block 24.

The metal gasket 20 of the first exemplary embodiment has a functional layer 26 with plurality of inner peripheries 28 which surround a plurality of openings 30 that correspond with the combustion chambers of the internal combustion engine. In the exemplary embodiment, the openings 30 of the metal gasket 20 have circular shapes and are spaced from one another to correspond with the combustion chambers of the engine block 24. It should be appreciated that, depending on the specific application of the metal gasket 20, the opening or openings 30 could have any suitable shape.

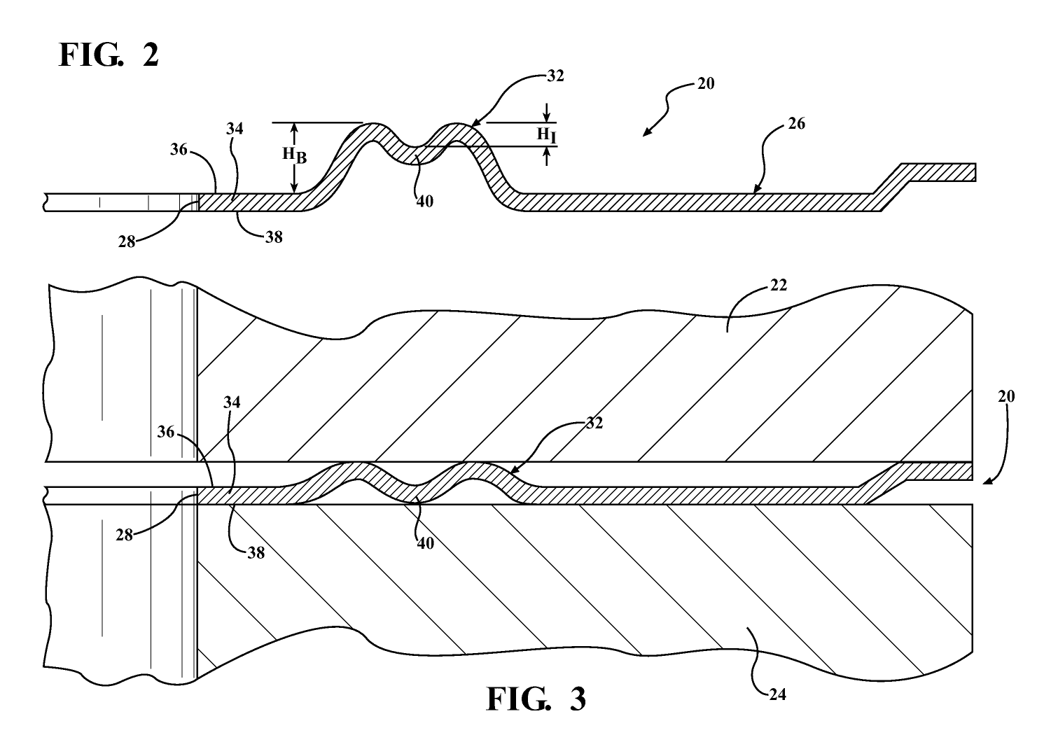

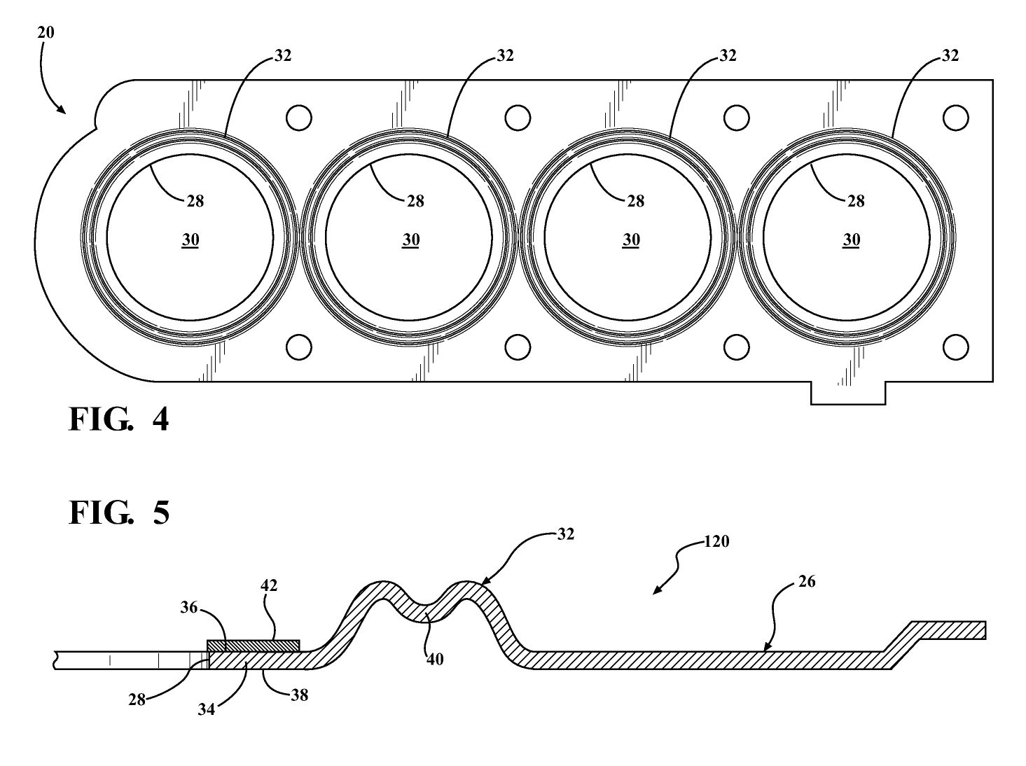

Referring now to the cross-sectional view of FIG. 2, the functional layer 26 further includes an embossment bead 32 which is spaced radially from the inner periphery 28 and circumferentially surrounds each of the circular openings 30. The functional layer 26 has a generally flat portion 34 which extends radially between the inner periphery 28 and the embossment bead 32. The generally flat portion 34 of the functional layer 26 has a first surface 36 (or a top surface 36) and a second surface 38 (or a bottom surface 38), and the embossment bead 32 extends in a first axial (or vertical) direction from the generally flat portion 34. As shown, the embossment bead 32 includes an indentation 40 which extends in a second axial (or vertical) direction, which is opposite of the first axial direction, from the top or apex of the embossment bead 32, thereby giving the embossment bead 32 an M or W-shape with two convex curves (or downwardly facing curves) and a single concave curve (or an upwardly facing curve) when viewed in cross-section and when in a relaxed or uncompressed condition. The embossment bead 32 on the exemplary functional layer 26 extends in the first axial direction to a bead height H_{B} (which is the vertical distance from the first surface 36 of the generally flat portion 34 to the apexes of the embossment bead 32) which is greater than 0.15 mm and is no greater than 0.30 mm (0.15 mm<H≦0.30 mm) when the functional layer 26 is in the relaxed condition. Most preferably, the bead height H_{B} of the embossment bead 32 when the functional layer 26 is in the relaxed condition is in the range of 0.19 to 0.25 mm. These ranges are relatively high as compared to the bead heights of many other known gasket assemblies with M or W-shaped embossment beads. The relatively high bead height H_{B} provides for reduced forming stresses on the functional layer 26 as well as increased fatigue resistance for the embossment bead 32.

The indentation 40 of the embossment bead 32 extends in the second axial (or vertical) direction by an indentation height H_{I} when the functional layer 26 is in the relaxed condition, and the indentation height H_{I} is less than the bead height H_{B} of the embossment bead 32. As such, the bottom of the indentation 40 is spaced vertically above the generally flat portion 34 of the functional layer 26 when the functional layer 26 is in the relaxed condition.

Referring now to FIG. 3, when the functional layer 26 is compressed between the cylinder head 22 and the engine block 24, the embossment bead 32 deflects elastically and plastically to maintain the gas and air tight seal between the cylinder head 22 and the engine block 24. The cylinder head 22 is clamped down until the bottom of the indentation 40 engages against the engine block 24 to provide the embossment bead 32 on the functional layer 26 with three total points of contact or seals when viewed in cross-section. Specifically, when clamped between the cylinder head 22 and the engine block 24, the embossment bead 32 has two points of contact with the cylinder head 22 and one point of contact with the engine block 24. These three points of contact provide for improved sealing performance, particularly when the cylinder head 22 lifts off of the engine block 24 during operation of the engine. It should be appreciated that the metal gasket 20 could alternately be flipped by 180° relative to the orientation shown in FIG. 3 such that the embossment bead 32 has two points of contact with the engine block 24 and one point of contact with the cylinder head 22 as viewed in cross-section.

Referring back to the cross-sectional view of FIG. 2, the exemplary embodiment of the metal gasket 20 is a single layer gasket having a single functional layer 26. However, it should be appreciated that the functional layer 26 may be employed in a multi-layer gasket assembly with one or more additional functional layers and/or one or more distance layers (not shown) if desired. The functional layer 26 may include one or more additional embossment beads (e.g., half embossment beads) spaced radially from the M or W-shaped embossment bead 32 with the indentation 40.

The metal gasket 20 may be formed of a range of different metals or combination of metals including, for example, steel, copper, aluminum, etc. The embossment bead 32 is preferably formed into the functional layer 26 through an embossing process.

Referring now to FIG. 5, a second exemplary embodiment of the metal gasket 120 is generally shown in cross-section. This exemplary embodiment is similar to the first exemplary embodiment of the metal gasket 20 described above but further includes a stopper feature 42 or element which is separate from and adjacent to the embossment bead 32. In operation, the stopper element 42 restricts full compression of embossment bead 32 when the metal gasket 120 is compressed between the cylinder head 22 and the engine block 24. In this exemplary embodiment, the stopper feature 42 is a separate element and is affixed to the functional layer 26 at the generally flat portion 34 adjacent the embossment bead 32. However, it should be appreciated that the stopper feature could take many forms. For example, the stopper feature could be formed integrally with the functional layer or it could be a portion of an additional layer, such as a second functional layer or a distance layer, of a multi-layer gasket assembly.

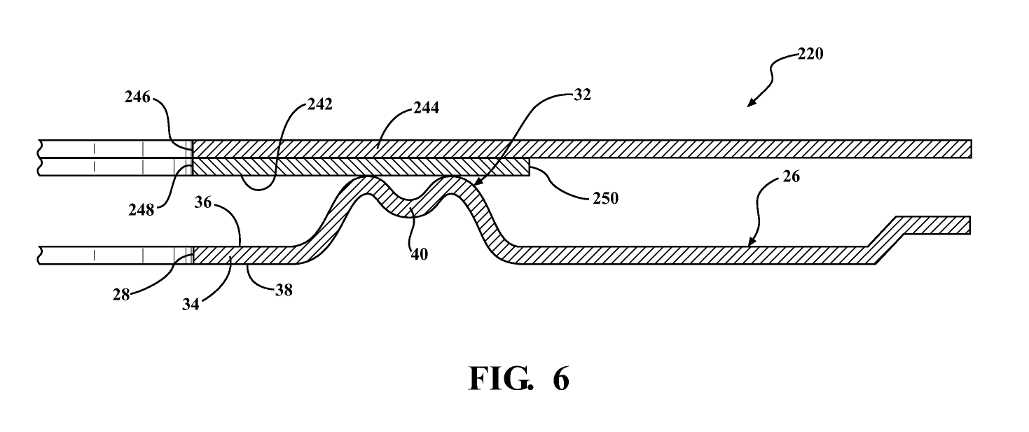

Referring now to FIG. 6, an exemplary embodiment of a multi-layer gasket assembly 220 is generally shown in cross-section. This exemplary embodiment includes a functional layer 26 which is similar to the first exemplary embodiment described above but further includes a distance layer 244 with a stopper 242 attached thereto. The distance layer 244 and stopper 242 overly the functional layer 26 and have openings which correspond with the openings in the functional layer 26. The distance layer 244 extends from an inner periphery 246 which is aligned with the inner periphery 28 of the functional layer 26 to an outer periphery which is spaced radially outwardly from the embossment bead 32 on the functional layer 26. The stopper 242 also extends from an inner periphery 248 which is aligned with the inner periphery 28 of the functional layer 26 to an outer periphery 250 which is spaced radially outwardly from the embossment bead 32 on the functional layer 26. As such, the stopper 242 extends radially across the embossment bead 32 on the functional layer 26. This particular embodiment may be advantageous because the stopper 242 drives an increased load into the embossment bead 32 on the functional layer 26 which may improve the seal provided by the gasket assembly 220 during lifting of the cylinder head off of the engine block. The distance layer 244 and the stopper 242 are preferably formed of metal and may be joined to one another through any suitable process including, for example, welding.

Obviously, many modifications and variations of the present invention are possible in light of the above teachings and may be practiced otherwise than as specifically described while within the scope of the appended claims.

What is claimed is:

1. A metal gasket for establishing a seal between a first member and a second member, comprising:
at least one functional layer having an inner periphery surrounding an opening, said functional layer having a generally flat portion and having an embossment bead which is spaced from said inner periphery and surrounds said opening and extends in a first direction away from said generally flat portion;
said embossment bead on said functional layer including an indentation which extends in a second direction opposite of said first direction for providing said embossment bead with three points of contact as viewed in cross-section when compressed between the first and second members; and
said embossment bead having a bead height of greater than 0.15 mm and no greater than 0.30 mm when in an uncompressed state.

2. The metal gasket as set forth in claim 1 wherein bead height of said embossment bead is in the range of 0.19 to 0.25 mm.

3. The metal gasket as set forth in claim 1 further including a stopper feature for restricting full flattening of said embossment bead between the first and second members.

4. The metal gasket as set forth in claim 1 wherein said indentation has an indentation height that is less than said bead height.

5. The metal gasket as set forth in claim 1 wherein said at least one functional layer includes a plurality of openings.

6. The metal gasket as set forth in claim 5 wherein at least one of said openings is generally circular in shape.

7. A metal gasket for establishing a seal between a first member and a second member, comprising:
at least one functional layer having an inner periphery surrounding an opening, said functional layer having a generally flat portion and having an embossment bead which is spaced from said inner periphery and surrounds said opening and extends in a first direction away from said generally flat portion;
said embossment bead on said functional layer including an indentation which extends in a second direction opposite of said first direction for providing said embossment bead with three points of contact as viewed in cross-section when compressed between the first and second members; and
a stopper feature which is separate from and adjacent to said embossment bead for restricting full flattening of said embossment bead between the first and second members.

8. The metal gasket as set forth in claim 7 wherein said embossment bead has a bead height of greater than 0.15 mm and no greater than 0.30 mm when in an uncompressed state.

9. The metal gasket as set forth in claim 8 wherein said indentation of said embossment bead has an indentation height that is less than said bead height of said embossment bead.

10. The metal gasket as set forth in claim 7 wherein said at least one functional layer includes a plurality of openings.

11. The metal gasket as set forth in claim 10 wherein at least one of said openings is generally circular in shape.

12. A multi-layer gasket assembly for establishing a seal between a first member and a second member, comprising:
at least one functional layer having an inner periphery surrounding an opening, said functional layer having a generally flat portion and having an embossment bead which is spaced from the inner periphery and surrounds said opening and extends in a first direction away from said generally flat portion;
said embossment bead on said functional layer including an indentation which extends in a second direction opposite of said first direction;
a distance layer overlying said functional layer; and
a stopper sandwiched between said distance layer and said functional layer and extending radially across said embossment bead.

13. The multi-layer gasket assembly as set forth in claim 12 wherein said embossment bead has a bead height of greater than 0.15 mm and no greater than 0.30 mm when in an uncompressed state.

14. The multi-layer gasket assembly as set forth in claim 13 wherein said indentation has an indentation height that is less than said bead height of said embossment bead.

15. The multi-layer gasket assembly as set forth in claim 12 wherein said functional layer and said distance layer have a plurality of openings.
